(19) United States
(12) Patent Application Publication
(10) Pub. No.: US 2003/0214184 A1
(43) Pub. Date: Nov. 20, 2003

(54) Dual coil variable reluctance wheel speed sensor

(76) Inventor: David J. Taneyhill, Niles, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/147,561

(22) Filed: May 16, 2002

(51) Int. Cl. B60T 8/66

(52) U.S. Cl. 303/168

(57) ABSTRACT

A wheel speed sensor system is disclosed which produces an output directly at the sensor. The sensor utilizes two separate coils that are wound out of phase from each other and exhibit a relatively high signal-to-noise ratio. Also disclosed is an anti-skid braking system that utilizes the wheel speed sensor system.

### FIELD OF THE INVENTION

The present invention relates to a sensor assembly for sensing the angular velocity of a rotating body. In particular, the invention relates to a sensor assembly for determining the angular velocity of a vehicle wheel. The present invention also relates to an anti-skid system utilizing an improved sensor assembly for sensing the angular velocity of a wheel controlled by the anti-skid system. Although the invention may be used in a variety of applications, it is particularly adapted for measuring vehicle wheel speed.

### BACKGROUND OF THE INVENTION

Inductive magnetic sensors are commonly used for automotive applications and the like to provide timing signals which enable the determination of position and speed of a rotating wheel. For example, specific applications may include the determination of engine crankshaft position and speed (i.e., RPM) and the determination of wheel speed for anti-lock braking systems. Inductive magnetic sensors generally used for these types of applications are commonly referred to as variable reluctance sensors.

The variable reluctance sensor is generally located adjacent to a rotating wheel which typically has a plurality of circumferentially spaced slots formed therein. The sensor has an inductive magnetic pick-up that generally comprises a pick-up coil wound on a core composed of magnetic or ferrous material. As the wheel rotates relative to the pick-up coil, an alternating voltage is generated in the pick-up coil when the slots on the wheel travel past the sensor. The alternating voltage must then be correctly decoded to recognize periodic high or positive voltage levels. The frequency of the alternating voltage is then determined to obtain rotational speed information about the wheel.

The more turns the coil is wound on a core, the larger the peak-to-peak voltage will be in the output of the coils in any variable reluctance sensor. A coil needs to have more turns to create a high voltage in order to send an undistorted signal to an electronic control unit. However, the higher the voltage, the higher the temperature of the coils. In order to wind the coils with more turns around a core, a wire with a small diameter is required.

Examples of prior wheel speed sensing systems are shown in U.S. Pat. Nos. 3,854,556; 3,938,112; 3,961,215; 3,988,624; and 4,029,180, all of which are hereby incorporated by reference. Typically, such prior systems utilize a ferromagnetic rotor rotatable with a vehicle wheel and a sensing device opposing the rotor across an air gap and fixed against rotation, such as to an axle housing of the vehicle. The air gap may be axial or radial. The sensing device is typically of an electromagnetic type with an output signal of frequency proportional to the angular velocity of the rotor. In sensors of this general type, a continuing problem has been the presence of false information or noise in the output signal of the sensing device due to variations in the size of the air gap during operation. These variations are often due, for example, to rotor vibration or runout in the direction of the air gap. Such false information or noise in the output signal may cause production of improper lock signals in an anti-lock system.

Past attempts to overcome this problem have included, for example, manufacture of components to close tolerances or elaborate sensor mounting techniques. However, these approaches have been costly and unsatisfactory.

Another prior approach to the problem is disclosed in the previously noted U.S. Pat. No. 3,854,556 in which a rotor and stator assembly are mounted alongside a vehicle wheel such that the rotor rotates with the wheel and in close proximity to the stationary stator. The stator utilizes a particular configuration of coil windings and arrangement of magnetic elements which are said to eliminate noise or inaccurate sensor readings resulting from changes in the air gap distance. The assembly utilizes two separate coils that further increase the complexity of the system. Moreover, the structure and manufacture of that sensor system is relatively costly to produce, install, and maintain.

Accordingly, an object of the present invention is to provide a wheel speed sensor assembly having a high signal to noise ratio and that is relatively simple and inexpensive to produce.

Furthermore, many applications for wheel sensing devices involve exposure to temperatures as high as 180° C. Although some sensing devices may be able to withstand such high temperatures, it is desirable to provide a relatively simple and robust sensor that can withstand repeated and prolonged exposure to high temperatures.

Vehicle anti-skid systems typically employ a wheel speed sensor associated with each vehicle wheel being controlled. Each sensor provides a signal proportional to the angular velocity of its associated wheel. Each of these signals is utilized by anti-skid circuitry which, in dependence upon the signal value and derivatives thereof and perhaps that of other signals, provides a skid signal. This skid signal is then utilized to regulate the braking forces applied to one or more controlled wheels. Since the provision of the skid signal depends upon the sensed angular velocity of one or more wheels, it is exceedingly important that the sensor assembly provides a frequency signal which exhibits a high degree of accuracy. In view of the concern for retaining a high level of accuracy in the signal, it is undesirable to further subject the signal to numerous conversions or filtering operations.

Accordingly, it is a further object of the present invention to provide a wheel speed sensor assembly that is accurate and may readily be incorporated into an anti-skid braking system. That is, it would be particularly beneficial to provide a wheel speed sensor assembly that provided an accurate digital output directly from the sensor assembly.

The present invention meets these and other objects as more fully described herein.

### SUMMARY OF THE INVENTION

In a first aspect, the present invention provides a vehicle wheel speed sensor system adapted for providing a control signal indicative of the angular velocity of a vehicle wheel. This system includes a first coil secured or otherwise affixed to a vehicle and positioned adjacent to a wheel of the vehicle. The first coil provides a first output signal. The system also includes a second coil secured to the vehicle and positioned adjacent to the same wheel of the vehicle, and the second coil providing a second output. The first and second coils are wound out of phase with respect to each other. The speed sensor system further has a circuit having two inputs, each in communication with the first and second outputs of the noted first and second coils. The circuit provides a control signal indicative of the angular velocity of the vehicle wheel.

In another aspect, the present invention provides a vehicle anti-skid braking system. The system includes a collection of wheel speed sensor systems, a collection of braking assemblies, and an electronic control unit in communication with the wheel speed sensor systems and braking assemblies. Each of the wheel speed sensor systems is positioned adjacent to a vehicle wheel and provides a control signal output that is indicative of the angular velocity of the wheel. Each of the braking assemblies is also positioned adjacent to a corresponding wheel and is adapted for receiving a control signal for selectively applying braking force to that wheel. The electronic control unit is in communication with the collection of wheel speed sensor systems and the collection of braking assemblies and provides one or more control signals for the collection of brake assemblies. Each control signal is transmitted by the electronic control unit to a corresponding braking assembly for selectively applying braking force to each of the wheels of the vehicle. These control signals are based, at least in part, upon the signal control outputs from the collection of wheel speed sensor systems. Each of the wheel speed sensor systems includes a first coil adjacent to the vehicle wheel and a second coil adjacent to the vehicle wheel. The two coils are out of phase with respect to each other.

In yet another aspect, the present invention provides a vehicle anti-skid braking system for controlling braking of a vehicle. This system includes a first coil and a second coil secured to the vehicle and positioned in close proximity to a wheel of the vehicle. The two coils provide first and second control signals that are proportional to the angular velocity of the wheel. The first control signal is in the form of a sine wave upon rotation of the wheel. The second control signal is in the form of a cosine wave upon rotation of the wheel. The vehicle anti-skid braking system also includes a circuit in communication with the first and the second control signals for converting those signals to an output frequency signal which is proportional to the angular velocity of the wheel and in the form of a square wave upon rotation of the wheel. The vehicle anti-skid braking system additionally includes an electronic control unit having an input for receiving the output signal from the circuit and an output for transmitting a braking control signal. The input of the electronic control unit is in communication with the output signal of the circuit. The vehicle anti-skid braking system has a braking assembly associated with each of the wheels of the vehicle. The braking assembly has an input for receiving a braking control signal from the output of the electronic control unit and is adapted to apply a braking force to its corresponding wheel based upon the braking control signal. The input of the braking assembly is in communication with the output of the electronic control unit.

These and other aspects of the present invention are described below.

### BRIEF DESCRIPTION OF THE DRAWINGS

FIG. 1 is a schematic of a preferred embodiment wheel speed sensor system in accordance with the present invention; and

FIG. 2 is a schematic of a preferred embodiment anti-skid braking system utilizing the preferred wheel speed sensor system in accordance with the present invention.

### DETAILED DESCRIPTION OF THE PREFERRED EMBODIMENTS

Generally, the present invention provides a wheel velocity sensor comprising two separate coils that are wound out of phase and apart magnetically around a core, and a back-biasing magnetic disk. During operation of the preferred embodiment sensor, described herein, when the sensor detects rotation of a corresponding wheel, the two coils produce two waveforms, each out of phase with respect to the other, e.g. a sine output signal and a cosine output signal. These two outputs are preferably connected to an R/S flip-flop circuit, but not limited to a particular electronic circuitry, such as may be provided within or external to the sensor assembly that provides an output signal. In certain preferred embodiments, the output signal is a square wave output. The output signal is then directly transmitted to an anti-lock brake system (ABS) electronic control unit (ECU) and accepted as the wheel speed sensor output. With additional circuitry, the power produced by the variable reluctance coils may be used as power to the electronics in the sensor assembly. The circuitry that interprets the analog output of the coils is next to the coils which does not require a large peak to peak voltage. As noted herein, because the coils utilize fewer turns than in comparative sensors, a more robust sensor is provided, thus improving the temperature and service conditions for the device. Since fewer turns are used, a larger diameter wire is used with a thicker wire insulation, thereby allowing the coil of the wire to survive through higher temperatures.

Preferably, the two separate coils are wound on the same core and share a common axis. The present invention includes numerous winding combinations of the two coils. For instance, a first and a second coil may be wound in essentially the same configuration on a common core. Alternately, the two coils may be wound along separate regions of a common core. And, the two coils may be wound along separate regions of a common core and overlap one another or at least share a region of the common core. The two coils may be wound in nearly any pattern or arrangement on the common core.

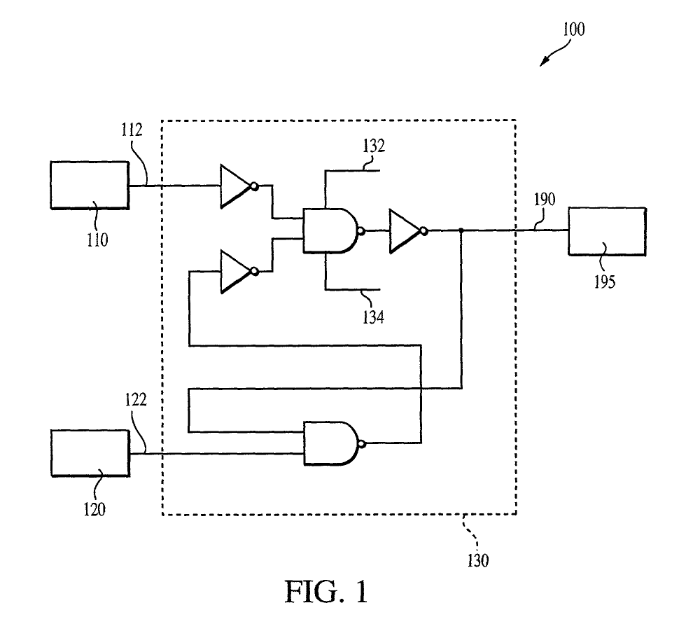

FIG. 1 illustrates a schematic of a preferred embodiment wheel speed sensor system 100. This system 100 comprises a first coil 110 and a second coil 120. Each of the coils is stationary and mounted or otherwise affixed to the vehicle. As noted, it is preferred that the two coils are wound upon a common core. The coils are positioned alongside the wheel whose angular velocity is to be monitored or measured. The coils 110 and 120 are configured from about 45° to about 135° out of phase with respect to each other and preferably about 90° out of phase. That is, the coils are positioned with respect to each other and with respect to the wheel such that they are out of phase with each other. The coil 110, upon sensing wheel rotation, produces an output 112 that corresponds to a first waveform and preferably a sine wave. The coil 120, upon sensing wheel rotation, produces an output 122 that corresponds to a second waveform out of phase with respect to said first waveform and preferably a cosine wave. The system further comprises an R/S flip-flop circuit 130 as known in the art. The outputs 112 and 122 are directed to the R/S flip-flop circuit 130. As will be appreciated, the circuit 130 is connected to a power source 132 and a ground 134. Upon receiving the coil outputs 112 and 122, the circuit 130 produces an output signal, which may be in the form of a square wave output signal 190. The square-wave signal 190 is directed to an anti-lock brake system (ABS) electronic control unit (ECU) 19.

It is contemplated that with additional circuitry, the power produced by the variable reluctance coils, i.e. coils 110 and 120 in FIG. 1, may be used as power to other electronics in the wheel speed sensor. Furthermore, if the wheel speed sensor is self-powered, then the ECU need only supply a relatively small voltage bias, e.g. 2.5 volts, at lower speeds to the wheel speed sensor.

It will be understood that the present invention is not limited to particular electronic circuits such as the noted R/S flip flop for receiving the outputs from the coils. It is envisioned that numerous signal processing elements could be used to receive the coil outputs, for example, an amplifier, an amplifier and filter, an analog to digital converter, such a converter with a Schmitt Trigger, and smart electronics such as based upon a microprocessor. Moreover, it is contemplated that depending upon the system, the electronic circuit at the sensor level could be eliminated and the coil outputs sent directly to an ECU. Accordingly, the output from the sensor, after appropriate processing, if necessary, may exhibit a wide array of waveforms. The present invention is not limited to the sensor output corresponding to a square wave output.

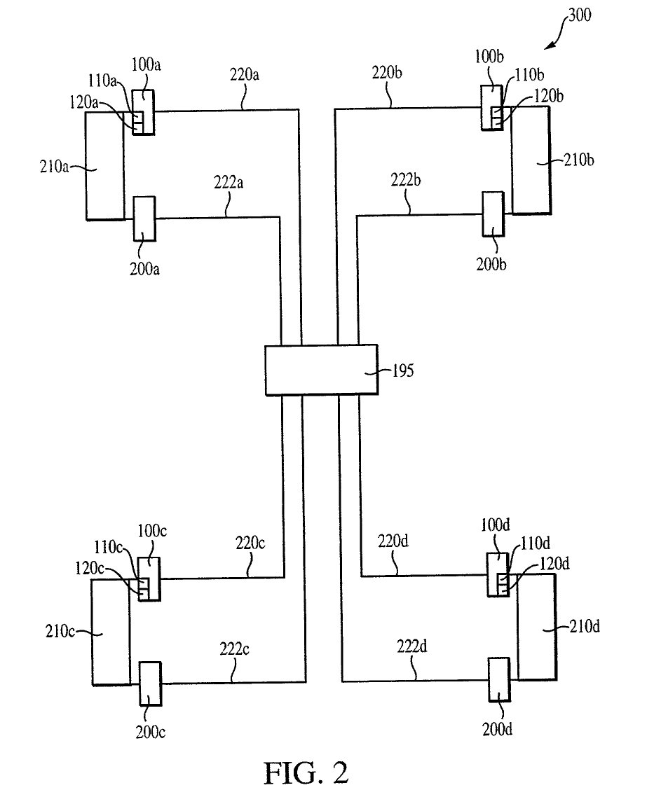

FIG. 2 illustrates a preferred embodiment anti-skid braking system utilizing the preferred embodiment wheel speed sensor system in accordance with the present invention. FIG. 2 illustrates a preferred anti-skid braking system 300 comprising a plurality of preferred wheel speed sensors 100a, 100b, 100c, and 100d. The system 300 depicted in FIG. 2 is used with four (4) wheels 210a, 210b, 210c, and 210d. The present invention anti-skid braking system can readily be used in conjunction with a lesser or greater number of wheels. The preferred embodiment anti-skid braking system 300 further comprises a plurality of braking assemblies 200a, 200b, 200c, and 200d. As will be appreciated, each wheel has a corresponding sensor and braking assembly associated with the wheel. Thus, wheel 210a has sensor 100a and braking assembly 200a associated with it. Wheel 210b has sensor 100b and braking assembly 200b associated with it. Wheel 210c has sensor 100c and braking assembly 200c associated with it. And wheel 210d has sensor 100d and braking assembly 200d associated with it.

Each of the respective sensors 100a-d and braking assemblies 200a-d are in electrical communication with the anti-lock brake system (ABS) electronic control unit (ECU) 195 described in FIG. 1. Corresponding electrical conductors 220a, 222a, 220b, 222b, 220c, 222c, 220d, and 222d are utilized to provide electrical signal communication between the sensors and braking assemblies and the ECU. As will be appreciated, the ECU 195 controls the braking assemblies 200a-d, at least in part, any information received-from the sensors 100a-d.

It will be appreciated that the square wave signal output 190 (FIG. 1) from each of the sensors 100a-d, is directly used by the ECU 195. And, it will be understood that each of the sensors 100a-d includes two coils (such as coils 110 and 120 in FIG. 1) that provide respective waveforms, for instance sine and cosine outputs. Each pair of coils is illustrated in FIG. 2 as 110a-d and 120a-d. Each pair of waveforms, e.g. sine and cosine outputs, is directly utilized by a respective sensor 100a-d at a corresponding wheel 210a-d to provide a highly accurate square wave output that is transmitted to the ECU 195 by a corresponding conductor 220a-d. The ECU 195 in turn, transmits output signals via conductors 222a-d to control each of the respective braking assemblies 200a-d.

The preferred embodiment wheel speed sensor system is believed to provide a significant improvement over currently known relatively sensitive sensor designs. That is, the preferred embodiment sensor system is relatively simple and utilizes coils having fewer windings or turns as compared to comparable sensors. Accordingly, a more robust magnetic wire may be used, thereby increasing the high temperature operating limits of the sensor.

The foregoing description is, at present, considered to be preferred embodiments of the present invention. However, it is contemplated that various changes and modifications apparent to those skilled in the art may be made without departing from the present invention. Therefore, the foregoing description is intended to cover all such changes and modifications encompassed within the spirit and scope of the present invention, including all equivalent aspects.

We claim:

1. A vehicle wheel speed sensor system adapted for providing a control signal indicative of the angular velocity of a vehicle wheel, said system comprising:
a first coil affixed to a vehicle and disposed adjacent to a wheel of said vehicle, said first coil providing a first output;
a second coil affixed to said vehicle and disposed adjacent to said wheel of said vehicle, said second coil providing a second output, the first and second coils being out of phase with respect to each other; and
a circuit having a first input in communication with said first output of said first coil, a second input in communication with said second output of said second coil, and said circuit providing said control signal indicative of the angular velocity of said vehicle wheel.

2. The vehicle wheel speed sensor of claim 1 wherein said first and second coils are 90° out of phase.

3. The vehicle wheel speed sensor of claim 1 wherein said first output corresponds to a first waveform.

4. The vehicle wheel speed sensor of claim 3 wherein said second output corresponds to a second waveform out of phase from said first waveform.

5. The vehicle wheel speed sensor of claim 1 wherein said control signal provided by said circuit corresponds to a square wave.

6. The vehicle wheel speed sensor of claim 1 wherein said first output corresponds to a sine wave, said second output corresponds to a cosine wave, and said control signal provided by said circuit corresponds to a square wave.

7. The vehicle wheel speed sensor of claim 1 wherein said first and second coils are from about 45° to about 135° out of phase.

8. The vehicle wheel speed sensor of claim 7 wherein said circuit is an R/S flip-flop circuit.

9. A vehicle anti-skid braking system adapted for controlling braking of a vehicle having a plurality of wheels, said system comprising:
a plurality of wheel speed sensor systems, each of said sensor systems disposed proximate to a wheel and providing a control output indicative of the angular velocity of said wheel;
a plurality of braking assemblies, each of said braking assemblies disposed proximate to a wheel and adapted for receiving a control signal for selectively applying braking force to said wheel; and
an electronic control unit in communication with said plurality of wheel speed sensor systems and said plurality of braking assemblies, and providing a plurality of control signals for said plurality of brake assemblies, each said control signal transmitted to a corresponding braking assembly for selectively applying braking force to said wheel, said plurality of control signals based at least in part upon said control outputs from said plurality of wheel speed sensor systems,
wherein each of said wheel speed sensor systems includes (i) a first coil adjacent to said vehicle wheel, and (ii) a second coil adjacent to said vehicle wheel, said first and second coils being out of phase with respect to each other.

10. The vehicle anti-skid braking system of claim 9 wherein said first and second coils are 90° out of phase.

11. The vehicle anti-skid braking system of claim 9 wherein said control output of each of said wheel speed sensors is a square wave.

12. The vehicle anti-skid braking system of claim 9 wherein for each of said wheel speed sensor systems, said first coil provides a first coil output corresponding to a sine wave upon rotation of said wheel disposed proximate to said sensor system, and said second coil provides a second coil output corresponding to a cosine wave upon rotation of said wheel disposed proximate to said sensor system.

13. The vehicle anti-skid braking system of claim 12 wherein said control output of said sensor system corresponds to a square wave.

14. The vehicle anti-skid braking system of claim 9 wherein said first and second coils are from about 45° to about 135° out of phase.

15. A vehicle anti-skid braking system for controlling braking of a vehicle, said system comprising:
a first coil secured to said vehicle and positioned in close proximity to a wheel of said vehicle, said first coil providing a first control signal proportional to the angular velocity of said wheel and in the form of a first waveform upon rotation of said wheel;
a second coil secured to said vehicle and positioned in close proximity to said wheel of said vehicle, said second coil providing a second control signal proportional to the angular velocity of said wheel and in the form of a second waveform out of phase with respect to said first waveform upon rotation of said wheel;
a circuit in communication with said first and said second control signals for converting said first and said second control signals to an output signal proportional to the angular velocity of said wheel and in the form of a square wave upon rotation of said wheel;
an electronic control unit having an input for receiving said output signal from said circuit and an output for transmitting a braking control signal, said input of said electronic control unit being in communication with said output signal of said circuit; and
a braking assembly associated with said wheel of said vehicle, said braking assembly having an input for receiving said braking control signal from said output of said electronic control unit, said braking assembly adapted to apply a braking force to said wheel based upon said braking control signal, and said input of said braking assembly being in communication with said output of said electronic control unit providing said braking control signal.

16. The vehicle anti-skid braking system of claim 15 further comprising:
a third coil secured to said vehicle and positioned in close proximity to a second wheel of said vehicle, said third coil providing a third control signal proportional to the angular velocity of said second wheel and in the form of a third waveform upon rotation of said second wheel;
a fourth coil secured to said vehicle and positioned in close proximity to said second wheel, said fourth coil providing a fourth control signal proportional to the angular velocity of said second wheel and in the form of a fourth waveform out of phase with respect to said third waveform upon rotation of said second wheel;
a second circuit in communication with said third and fourth control signals for converting said third and fourth control signals to a second output signal proportional to the angular velocity of said second wheel and in the form of a square wave upon rotation of said second wheel;
said electronic control unit further having a second input for receiving said second output signal from said second circuit and a second output for transmitting a second braking control signal; and
a second braking assembly associated with said second wheel of said vehicle, said second braking assembly having an input for receiving said second braking control signal, said braking assembly adapted to apply a braking force to said second wheel upon receiving said second braking control signal.

17. A wheel speed sensor for providing a control signal comprising:
a first coil wound around a core; and
a second coil wound separately from said first coil around the core, wherein said first coil and said second coil are out of phase with respect to each other.

18. The wheel speed sensor of claim 17 wherein said first and said second coils are from about 45° to 135° out of phase.

19. The wheel speed sensor of claim 17 wherein said first and said second coils are 90° out of phase.
